(19) United States
(12) Patent Application Publication
(10) Pub. No.: US 2024/0169544 A1
(43) Pub. Date: May 23, 2024

(54) METHODS AND SYSTEMS FOR BIOMEDICAL IMAGE SEGMENTATION BASED ON A COMBINATION OF ARTERIAL AND PORTAL IMAGE INFORMATION

(71) Applicant: ONCORADIOMICS, Liege (BE)

(72) Inventors: Akshayaa VAIDYANATHAN, Liege (BE); Ingrid VAN PEUFFLIK, Uikhoven (BE)

(73) Assignee: ONCORADIOMICS, Liege (BE)

(21) Appl. No.: 18/283,041

(22) PCT Filed: Mar. 6, 2022
(86) PCT No.: PCT/EP2022/055656

§ 371 Date: Sep. 20, 2023

(30) Foreign Application Priority Data
Apr. 2, 2021 (BE) 2021/5259

(51) Int. Cl. G06T 7/11

(52) U.S. Cl. CPC G06T 7/11; G06T 2207/10081; G06T 2207/10088; G06T 2207/10104; G06T 2207/10116; G06T 2207/20081; G06T 2207/20084; G06T 2207/30056; G06T 2207/30096; G06T 2207/30101; G06T 2207/30204

(57) ABSTRACT

Methods and systems for biomedical image segmentation based on a combination of arterial and portal image information Methods and systems for biomedical image segmentation based on a combination of arterial and portal image information are described. The combination of arterial and portal image information is helpful in improving biomedical image segmentation when the different phases of images are not properly registered for example due to respiration-induced motion of a patient or one of the phases have missing manual reference. A preferred embodiment is the segmentation or prediction of liver cancer or hepatocellular carcinoma.

### BACKGROUND

This invention relates to the field of radiomics and computer aided diagnosis using machine learning models, in particular convolutional neural networks for image segmentation in enhanced X-ray imaging techniques. A preferred embodiment is the segmentation of liver images obtained by radiocontrast computed tomography, also referred to as contrast CT.

Radiomics stands for constructed descriptive models based on medical imaging data that are capable of providing relevant and beneficial predictive, prognostic or diagnostic information. In general, radiomics comprises the following four main data processing steps:
Image acquisition/reconstruction;
(ii) Image segmentation;
(iii) Feature extraction and quantification, and
(iv) Statistical analysis and model building.

For example, EP2987114 Maastro Clinic describes a method for obtaining a radiomics signature model of a neoplasm that enables to distinguish specific phenotypes of neoplasms. The signature model is based on following image feature parameters: gray-level non-uniformity, wavelet high-low-high gray-level non-uniformity, statistics energy, and shape compactness.

EP3207521 to Maastro Clinic. This document describes an image analysis method wherein image features of a neoplasm obtained at a first point in time are compared to a later-in-time image. The resulting delta is then weighted and combined to obtain a predictive value.

Deep learning-based radiomics has recently emerged. It partially or fully combines feature extraction and analysis. Consequently, deep learning is increasingly used in image segmentation. Deep Learning-based models employ multiple layers of models to generate an output fora received input. For example, a deep neural network includes an output layer and one or more hidden layers that each apply a non-linear transformation to a received input to generate an output. An example of a deep learning-based model for biomedical image segmentation are convolutional neural networks, so-called segmentation neural networks.

An example of a segmentation neural network is the U-Net neural network architecture as described in Ronneberger et al. 2015, U-Net: Convolutional Networks for Biomedical Image Segmentation, arXiv:1505.04597v1. Such a model is shown in FIG. 1

BE2020/5976 to Oncoradiomics describes an a deep learning based segmentation method for biomedical images through a U-Net associated with an attention gated skip connection that leads to improved prediction accuracy as expressed by the Dice coefficient.

EP20215700 to Oncoradiomics describes an automated image segmentation method, wherein the image shape is first defined and then modified. Feature parameters are derived based on both the defined image shape and the modified image shape. A predictive value is obtained based on the feature parameters derived from the defined image shape and the modified image shape and reference values.

A particularly important application of biomedical image segmentation is liver cancer, or hepatocellular carcinoma, also referred to as HCC. HCC is one of the most frequent cancers nowadays.

CN104463860 to Feng Binghe describes an automized liver segmentation method. Branch points of the portal vein, the hepatic vein, and the hepatic artery are acquired by extracting the surface of the blood vessel.

EP3651115 to Shanghai United Healthcare describes an automized liver segmentation method wherein a plurality of marked points are determined based on the segmentation information. The marked points are then used to determine curved surfaces through lines of intersection between the flat surfaces using an interpolation algorithm.

CN110992383 to Tianjin Jingzhen Medical Tech describes a CT image liver artery segmentation method based on deep learning. The image size is adjusted to a fixed size and then normalized. A neural network is trained and its output calculated as well as a loss value of a liver artery mask. The loss is then used to update the parameters of the neural network.

However, none of the prior art liver lesion segmentation methods describe how to deal with inconsistencies in multi-phase images due to the following factors
1) registration errors associated with respiration induced motion in the liver,
2) registration errors due to the differences in scanner settings (when the images at different phases are captured at different timepoints (>1 min) using different scanning protocol (reconstruction kernel) and image parameters (pixel spacing, slice thickness etc.)

3) unavailability of segmentation ground-truth (manual reference) for one of the phases
4) Invisible region of interest (lesion, tumor etc.) in one of the phases

Motion correction based on the quantitative analysis of respiration-related movement of abdominal artery has already been proposed, for example by Lin 2015, PLOS ONE 10(6) e0131794. https://doi.orq/10.1371/joumal.pone.0131794.

However, there still is a need to provide an improved biomedical image segmentation method in particular for liver carcinoma, when images are not properly registered, for example due to motion, in particular respiration-induced motion.

### SHORT DESCRIPTION OF THE INVENTION

The present inventors now have surprisingly found that the training on first or second phase images with several inconsistencies associated with registration errors and missing manual reference for one phases using preprocessing, augmentation and the combination of information from the arterial and portal phase images of contrast enhanced CT or MRI in deep learning radiomics models generates improved segmentation and predictive values for liver cancer. In one embodiment, a dice coefficient on the validation data of 0.6 or more, preferably of 0.7 ore more may be obtained.

Accordingly, a first aspect of the invention is a biomedical image segmentation method performed by one or more data processing apparatus and comprising following steps:
a) receiving a request to generate a plurality of possible segmentations of a biomedical image obtained by radiocontrast enhanced x-ray imaging technology;
b) generating a plurality of possible segmentations using deep learning-based radiomics models;
wherein the deep learning-based radiomics model has been trained on first or the second phase images with inconsistencies associated with registration and missing manual reference for one of the phases using a multi-channel input comprising a
1) first channel with a first phase image;
2) second channel with a second phase image; and
3) optionally a third channel with a pre-processed first phase image; and wherein one or more of the following pre-processing steps have been performed:
   In cases where one of the first or second phase image has no mask, also referred to as manual reference, co-registration of the first and the second phase images while keeping the image and the mask of the phase containing the manual reference fixed and by interpolating the image of the phase not containing the manual mask;
   In cases where the mask is present for the first and the second image, the model is trained on two versions of the same image, where both the versions has image and mask corresponding to one or the other phase fixed and image and mask corresponding one or the other phase interpolated;
   In cases where the image corresponding to one of the phases is missing, the channel corresponding to the phase is populated with a constant value of an Hounsfield unit from −1800 to −1000, preferably −1000
   and
wherein one or more augmentation steps have been performed on the pre-processed images:
   randomly shifting of one or more of the first and the second phase images or deformation while keeping the manual reference fixed during training;
   randomly populating a constant value of an Hounsfield unit from −1800 to −1000, preferably −1000 on one of the first and second channels during training

In another aspect, the inconsistencies in the images are due to one or more of the following factors:
The first phase or the second phase image are not properly registered due to motion of the patient between the first and the second phase,
The first and second phase images are captured at different time periods extending more than 120 seconds with different scanning protocols, reconstruction kernels etc.;
The first and second phase images are captured with different radiocontrast enhanced x-ray imaging scanners or scanning protocols;
The manual reference is available for only one of the first or the second phase image;
Image corresponding to only one of the first or the second phases are present;
The region of interest is only visible in one of the first or the second phases.

In another aspect, the organ of interest is the liver.

In another aspect, the first phase image is a portal phase image.

In another aspect, the second phase image is an arterial phase image.

In another aspect, the model input further comprises a third channel.

In another aspect, the third channel of the input to the model is an adaptive histogram equalization applied on the portal image.

In another aspect, the plurality of possible image segmentations are segmentations of liver cancer or hepatocellular carcinoma.

In another aspect, the first channel is randomly shifted or deformed while keeping the mask fixed.

In another aspect, the second channel comprising the second image is randomly shifted or deformed while keeping the mask fixed.

In another aspect, the slices are randomly shifted along the z axis.

In another aspect, the radiocontrast enhanced x-ray imaging technology is enhanced computed tomography, enhanced magnet resonance imaging, or enhanced positron emission tomography.

A further aspect of the invention is a system comprising one or more computers and one or more storage devices storing instructions that when executed by the one or more computers cause the one or more computers to perform the operations of the biomedical image segmentation method of the present invention.

A further aspect of the invention is one or more computer storage media comprising storing instructions that when executed by one or more computers cause the one or more computers to perform the operations of the biomedical image segmentation method of the present invention.

### SHORT DESCRIPTION OF THE DRAWINGS

FIG. 1 shows a first phase image of an enhanced CT of the liver.

FIG. 2 shows a second phase image of an enhanced CT of the liver.

FIG. 3 shows an adaptive histogram equalization applied on the first phase image.

FIG. 4 is a schematic representation of a U-Net architecture of the state of the art according to Ronneberger 2015.

FIG. 5 is a schematic representation of an exemplary embodiment of the architecture of the invention.

FIG. 6 is a schematic representation of an exemplary embodiment of an attention gating function (AG) according to the invention.

### DETAILED DESCRIPTION OF THE INVENTION

Enhanced CT and MRI

Radiocontrast agents are substances that enhance the visibility of internal structures in X-ray-based imaging techniques. Typical radiocontrast agents include iodine or barium-sulphate. Radiocontrast agents absorb external X-rays, resulting in decreased exposure on the X-ray detector.

A wide variety of screening technologies may be used for the segmentation method of the present invention including magnetic resonance imaging, also referred to as enhanced MRI and computed tomography, also referred to as enhanced CT. CT has grown quickly in every healthcare branch. The CT image is a cross-sectional view of the patient.

Phases in enhanced CT or MRI

In general, two or more phases are distinguished in contrast enhanced imaging technologies. In two phase CT or MRI of the liver, the arterial phase and the portal phase are distinguished. Each of the phases may be differentiated further through their early or late stage. A further third phase may include the washing out phase of the contrast agent.

In the arterial phase, the tissue loads the radiocontrast agent. This happens usually 35 seconds after the injection of the radiocontrast agent. The hepatic artery and the portal vein enhance, but not the hepatic veins. The arterial phase image is also referred to as an arterial image.

The portal venous phase usually occurs 80 seconds from the injection of the contrast agent. The tissue returns to a hypodense state in portal venous or later phases. This is a property of for example hepatocellular carcinoma as compared to the rest of the liver parenchyma. The portal phase image is also referred to as a portal image.

In liver cancer, the arterial phase usually offers better prediction values. However, in some cases the portal phase images are more reliable.

Image Registration

Image registration means systematically placing separate images in a common frame of reference so that the information they contain can be optimally integrated or compared.

Improperly Registered Images

Not properly registered or improperly registered images means, two images compared at a common frame of reference do not have overlapping region of interest. For example upon comparison of two images at same frame of reference, organ if interest, in particular the liver, appears shrunk due to for example respiration-based motion. The liver parenchyma is a relatively soft tissue. Thus, respiration can make registration of proper images difficult and can result in improper registration of the image. Not having the same image parameters (like slice thickness and pixel spacing) can also cause improper registration of images.

Image Segmentation Through CNN

Image segmentation creates a pixel-wise mask of each object in the images. The goal is to identify the location and shapes of different objects or targets, commonly referred to as “region of interest”, in the image by classifying every pixel in the desired labels.

CNN for image segmentation are developed by varying
the number of the convolutional and non-convolutional layers, also referred to as the depth of the network;
the order the layers are cascaded one after another;
the type of the input to the network comprising both single channel or multi-channel input, and/or;
the layer whose output is treated as the DLR features.

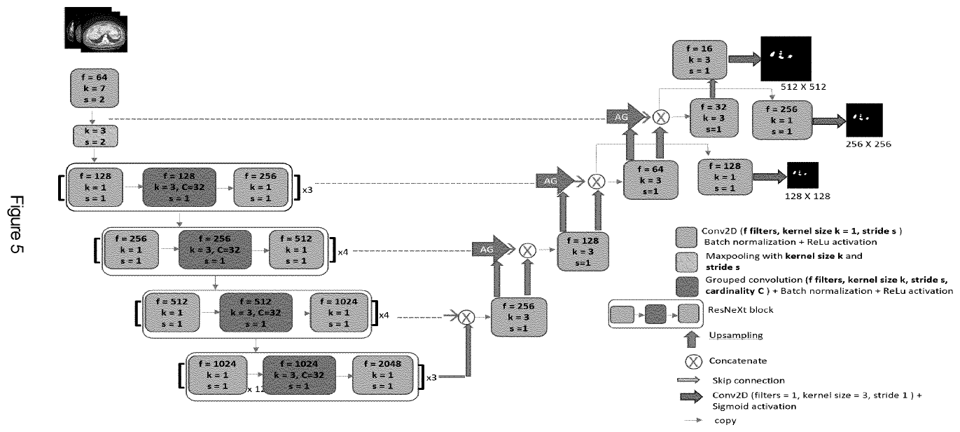

In one embodiment, the image segmentation method comprises the U-net architecture of the state of the art according to Ronneberger et al. 201, U-Net: Convolutional Networks for Biomedical Image Segmentation, arXiv:1505.04597v1. An embodiment of a U-Net architecture is in FIG. 4. It consists of a contracting path (left side) and an expansive path (right side). The repeated application of two 3×3 convolutions (unpadded convolutions) is followed by a rectified linear unit (ReLU) and a 2×2 max pooling operation with stride 2 for downsampling. At each downsampling step the number of feature channels is doubled. Every step in the expansive path consists of an upsampling of the feature map followed by a 2×2 convolution (“up-convolution”) that halves the number of feature channels, a concatenation with the correspondingly cropped feature map from the contracting path, and two 3×3 convolutions, each followed by a ReLU. The cropping is necessary due to the loss of border pixels in every convolution. At the final layer a 1×1 convolution is used to map each 64-component feature vector to the desired number of classes. In total, the network has 23 convolutional layers. Each grey box corresponds to a multi-channel feature map. The number of channels is denoted on top of the box. The x-y-size is provided at the lower left edge of the box. White boxes represent copied feature maps. The arrows denote the different operations.

In a preferred embodiment, the image segmentation method combines a U-Net and a ResNeXt with
an attention gated skip connection,
preferably further comprising a step of deep supervision on concatenation attention gated feature maps;
and even more preferably comprising upsampled feature maps from each step on decoder.

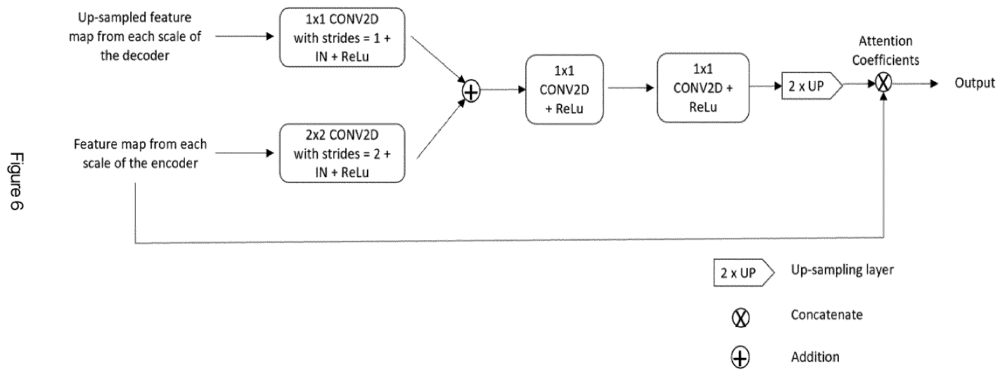

In a preferred embodiment, the image segmentation method comprises an attention gating function (AG) as shown in FIG. 5. This model is trained for the 3 outputs using the focal-tversky loss for the last layer and Tversky loss for the output from the intermediate layers.

The segmentation neural network includes a sequence of one or more “encoder” blocks, and a sequence of one or more “decoder” blocks. A “block” refers to a group of one or more neural network layers. Generally, the input to a block and the output of a block may be represented as respective arrays of numerical values that are indexed along one or more “spatial” dimensions (e.g., x-y dimensions, or x-y-z dimensions) and a “channel” dimension. The “resolution” of a block input/output along a dimension refers to the number of index values along that dimension.

In general, a 1×1 convolution simply maps an input pixel with all its channels to an output pixel, not looking at anything around itself. It is often used to reduce the number of depth channels, since it is often very slow to multiply volumes with extremely large depths.

In another preferred embodiment, the image segmentation method comprises an attention gating function (AG), in particular an attention gating function (AG) shown in FIG. 6.

Training of the CNN

The CNN is trained to extract radiomics features from tumor patches associated with individual CT series, also referred to as volume-level classification, with the objective of minimizing the difference between the predicted malignancy rate and the actual rate.

The input to a deep network can also be the combination of the original and segmented image along with any other pre-processed input such as a gradient image, commonly referred to as multi-channel input. Multi-channel input may be concatenated along the third dimension. The variety of input types can even go further to include images from different angles such as coronal and axial. The input can be the single slices, the whole volume or even the whole examinations associated with a specific patient.

Deformation

Spatial deformations such as rotation may be applied to the existing data in order to generate new samples for training purposes.

Histograms

A histogram is a graphical display of the pixel intensity distribution for a digital image. An x-ray beam is used to collect information about the tissues. The image is a cross-sectional map of the x-ray attenuation of different tissues within the patient. The typical CT scan generates a trans axial image oriented in the anatomic plane of the transverse dimension of the anatomy. Reconstruction of the final image can be reformatted to provide sagittal or coronal images. CT images show thin slices of tissue rather than superimposed tissues and structures. The pixel values show how strongly the tissue attenuates the scanner's x-ray beam compared to the attenuation of the same x-ray beam by water. Each pixel is the projection, or 2D representation, of the x-ray attenuation of a voxel, also referred to as volume element of physical tissue. The size of the pixels and the thickness of the voxels relate to important image quality features, such as detail, noise, contrast, accuracy of the attenuation measurement.

In a multidetector-row CT scanner, also referred to as multi-slice CT, this operation is performed simultaneously for many arrays of detectors stacked side by side along the z-axis of the patient, commonly referred to as the long axis of the patient.

Adaptive Histogram Equalization

Adaptive histogram equalization is a computer image processing technique used to improve contrast in images. It differs from ordinary histogram equalization in the respect that the adaptive method computes several histograms, each corresponding to a distinct section of the image, and uses them to redistribute the lightness values of the image. It is therefore suitable for improving the local contrast and enhancing the definitions of edges in each region of an image.

### EXAMPLE

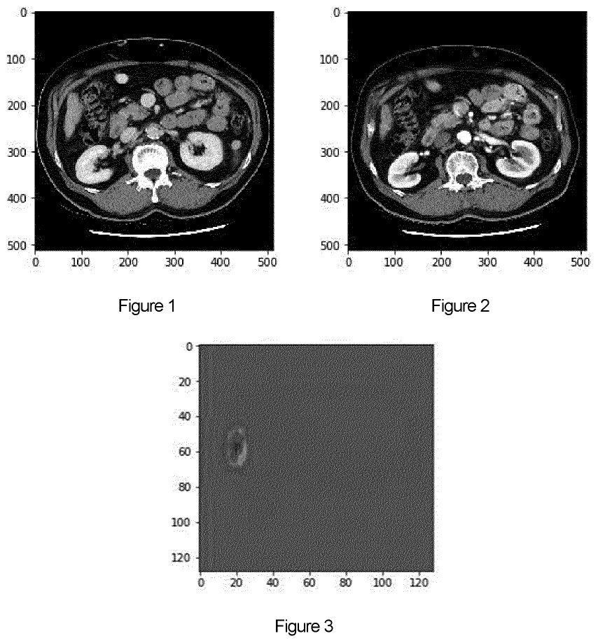

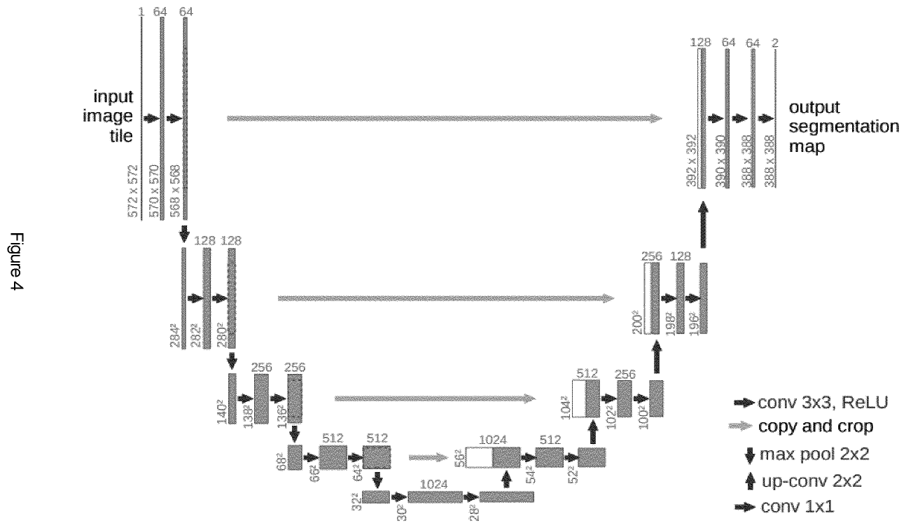

A deep learning radiomics model is trained on improperly registered arterial and portal phase CT images of the liver. The input channels are:
1) Channel 1: portal phase image of an enhanced CT of the liver as shown in FIG. 1.
2) Channel 2: arterial phase image of an enhanced CT of the liver as shown in FIG. 2.
3) Channel 3: Adaptive histogram equalization applied on portal phase image

To deal with the irregular registration due to respiration-induced motion, channel 1 and channel 2 was randomly shifted or deformed keeping the mask (manual reference)_fixed. For instance, the axial slices was randomly shifted along the z axis. (axial slice 16 is matched with axial slice 17). The Dice coefficient on the validation data was 0.74.

FIG. 4 is a schematic representation of a U-net architecture of the state of the art according to Ronneberger et al. 2015. Each grey box corresponds to a multi-channel feature map. The number of channels is denoted on top of the box. The x-y-size is provided at the lower left edge of the box. White boxes represent copied feature maps. The arrows denote the different operations.

FIG. 5 is a schematic representation of an exemplary embodiment of attention gating function (AG). This model is trained for the 300 iterations using the focal-tversky loss for the last layer and Tversky loss for the output from the intermediate layers.

The segmentation neural network includes a sequence of one or more “encoder” blocks, and a sequence of one or more “decoder” blocks. A “block” refers to a group of one or more neural network layers. Generally, the input to a block and the output of a block may be represented as respective arrays of numerical values that are indexed along one or more “spatial” dimensions (e.g., x-y dimensions, or x-y-z dimensions) and a “channel” dimension. The “resolution” of a block input/output along a dimension refers to the number of index values along that dimension.

In general, a 1×1 convolution simply maps an input pixel with all its channels to an output pixel, not looking at anything around itself. It is often used to reduce the number of depth channels, since it is often very slow to multiply volumes with extremely large depths.

FIG. 6 is a schematic representation of an exemplary embodiment of attention gating function (AG).

Table of abbreviations and expressions used
in the Figures for translation purposes:

| Abbreviation/Expression | Meaning and Translation |
|---|---|
| ReLu | Rectified linear unit |
| AG | Attention Gating function |
| ReLu activation | |
| Input image tile | |
| Output segmentation map | |
| Conv | Convolutional neural network |
| Copy and crop | |
| Max pool | |
| Up-conv | |
| Batch normalization | |
| Maxpooling with kernel size | |
| k and stride s | |
| Grouped convolution | |
| ResNeXt block | |
| Upsampling | |
| Concatenate | |
| Skip connection | |
| Sigmoid activation | |
| Copy | |
| Attention coefficient | |
| Output | |
| Upgraded feature map from | |
| each scale of the decoder | |
| Feature map from each | |
| scape of the encoder | |
| Upsampling layer | |

1. A biomedical image segmentation method performed by one or more data processing apparatus and comprising following steps:
a) receiving a request to generate a plurality of possible segmentations of a biomedical image obtained by radiocontrast enhanced x-ray imaging technology;
b) generating a plurality of possible segmentations using deep learning-based radiomics models;
wherein the deep learning-based radiomics model has been trained on one or more of the first or the second phase images with inconsistencies associated with registration and missing manual reference for one of the phases;
wherein a multi-channel input has been used comprising a
1) first channel with a first phase image;
2) second channel with a second phase image; and
3) optionally a third channel with a pre-processed first or second phase image; and
wherein one or more of the following pre-processing steps have been performed:
In cases where one of the first or second phase image has no mask (manual reference), co-registration of the first and the second phase images while keeping the image and the mask of the phase containing the manual reference fixed and by interpolating the image of the phase not containing the manual mask;
In cases where the mask was present for the first and the second image, training of the model on two versions of the same image, where both the versions have image and mask corresponding to one or the other phase fixed and image and mask corresponding one or the other phase interpolated;
In cases where the image corresponding to one of the phases is missing, the channel corresponding to the phase is populated with a constant value of an Hounsfield unit from −1800 to −1000, preferably −1000;
wherein one or more augmentation steps have been performed on the pre-processed images:
randomly shifting of one or more of the first and the second phase images or deformation while keeping the manual reference fixed during training;
randomly populating a constant value of an Hounsfield unit from −1800 to −1000, preferably −1000 on one of the first and second channels during training.

2. The biomedical image segmentation method according to claim 1, wherein the images are inconsistent due to one or more of the following registration errors:
The first phase or the second phase image are not properly registered due to motion of the patient between the first and the second phase,
The first and second phase images are captured at different time periods extending more than 120 seconds;
The first and second phase images are captured with different radiocontrast enhanced x-ray imaging scanners or scanning protocols;
The ground truth (manual reference) is available for only one of the first or the second phase image;
Only one of the first or the second phases are present;
The region of interest is only visible in one of the first or the second phases.

3. The biomedical image segmentation method according to claim 1, wherein the organ of interest is the liver.

4. The biomedical image segmentation method according to claim 1, wherein the first phase image is a portal phase image.

5. The biomedical image segmentation method according to claim 1, wherein the second phase image is an arterial phase image.

6. The biomedical image segmentation method according to claim 1, wherein the pre-processed first phase image is an adaptive histogram equalization applied on the portal image.

7. ‘The biomedical image segmentation method according to claim 1, wherein the plurality of possible image segmentations are segmentations of liver cancer or hepatocellular carcinoma.

8. The biomedical image segmentation method according to claim 1, wherein the first channel is randomly shifted or deformed while keeping the mask fixed.

9. The biomedical image segmentation method according to claim 1, wherein the second channel is randomly shifted or deformed while keeping the mask fixed.

10. The biomedical image segmentation method according to claim 1, wherein the slices are randomly shifted along the z-axis.

11. The biomedical image segmentation method according to claim 1, wherein the radiocontrast enhanced x-ray imaging technology is enhanced computed tomography, enhanced magnet resonance imaging, or enhanced positron emission tomography.

12. The biomedical image segmentation method according to claim 1, wherein the radiomics features are combined with further clinical data sources selected from the group consisting of gene expression, clinical characteristics, blood biomarkers or prognostic markers.

13. A system comprising one or more computers and one or more storage devices storing instructions that when executed by the one or more computers cause the one or more computers to perform the operations of the respective method of claim 1.

14. One or more computer storage media storing instructions that when executed by one or more computers cause the one or more computers to perform the operations of the respective method of claim 1.
